(19) United States
(12) Patent Application Publication
(10) Pub. No.: US 2024/0204461 A1
(43) Pub. Date: Jun. 20, 2024

(54) UNIVERSAL SERIAL BUS RECEPTACLE

(71) Applicant: Google LLC, Mountain View, CA (US)

(72) Inventors: Bernard ZHU, Mountain View, CA (US); Yongquan LI, Mountain View, CA (US); Billy LIU, Mountain View, CA (US); Enzo YEH, Mountain View, CA (US); Robin HUANG, Mountain View, CA (US); Burton WEI, Mountain View, CA (US); Beck QIN, Mountain View, CA (US)

(73) Assignee: Google LLC, Mountain View, CA (US)

(21) Appl. No.: 18/067,054

(22) Filed: Dec. 16, 2022

(51) Int. Cl. H01R 13/6584; H01R 13/52

(52) U.S. Cl. CPC H01R 13/6584; H01R 13/5202; H01R 2201/06

(57) ABSTRACT

A universal serial bus (USB) receptacle includes: an enclosure, a metal connector body positioned adjacent to the enclosure, and a conductive O-ring that surrounds the metal connector body and connects the metal connector body to the enclosure.

### BACKGROUND

The disclosure relates to a receptacle, and in particular to a universal serial bus receptable for a mobile device.

A wide variety of electronic devices employ a broad range of external electronic connectors to charge electronic devices and to communication with other devices. A common electronic connector uses universal serial bus (USB), which is a set of connectivity specifications. The transmission speed of data transferred in universal serial bus devices has increased with improved technology. For example, a universal serial bus 3.2 may increase the transmission speed to 20 gigabyte/second (Gb/s) and a universal serial bus 4.0 may increase the transmission speed to 40 Gb/s.

For data signals that are transmitted by universal serial bus hardware at a rate of 10 Gb/s or higher, the data signals may radiate and interfere with wireless communication receivers integrated in mobile device designs. The radiation causes radio frequency interference to integrated wireless receivers and can result in degraded wireless performance, such as reduced data throughput and poor user experience.

The background description provided herein is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

### SUMMARY

In some embodiments, a universal serial bus (USB) receptacle comprises: an enclosure, a metal connector body positioned adjacent to the enclosure, and a conductive O-ring that surrounds the metal connector body and connects the metal connector body to the enclosure.

In some embodiments, the USB receptacle is a USB-C receptacle. In some embodiments, the conductive O-ring forms a rectangle with rounded edges. In some embodiments, the enclosure further comprises a plastic part and a metal part. In some embodiments, the conductive O-ring connects the metal connector body to the metal part of the enclosure. In some embodiments, the metal part of the enclosure is made from aluminum. In some embodiments, the conductive O-ring is composed of conductive silicone. In some embodiments, the conductive O-ring is composed of liquid silicone rubber. In some embodiments, the conductive O-ring is waterproof. In some embodiments, the conductive O-ring is made from liquid injection molding.

In some embodiments, a mobile device comprises: a housing and a universal serial bus (USB) receptacle comprising: an enclosure, a metal connector body positioned adjacent to the metal enclosure, and a conductive O-ring that surrounds the metal connector body and connects the metal connector body to the enclosure.

In some embodiments, the USB receptacle is a USB-C receptacle. In some embodiments, the enclosure further comprises a plastic part and a metal part. In some embodiments, the conductive O-ring connects the metal connector body to the metal part of the enclosure. In some embodiments, the metal part of the enclosure is made from aluminum. In some embodiments, the conductive O-ring is composed of conductive silicone. In some embodiments, the conductive O-ring is composed of liquid silicone rubber. In some embodiments, the conductive O-ring is waterproof. In some embodiments, conductive O-ring shields the receptacle from radio frequency interference due to data signals carried through an electronic connector. In some embodiments, the conductive O-ring is made from liquid injection molding.

### BRIEF DESCRIPTION OF THE DRAWINGS

FIG. 1 is a diagram of a receptable on a mobile device, according to some embodiments described herein.

FIG. 2 is a diagram of an example universal serial bus receptable with a non-conductive O-ring, according to some embodiments described herein.

FIG. 3A is a diagram of a conductive O-ring, according to some embodiments described herein.

FIG. 3B is a diagram of the exterior of a universal serial bus receptacle with the conductive O-ring, according to some embodiments described herein.

FIG. 4 is a diagram of an interior of an example universal serial bus receptable with a conductive O-ring, according to some embodiments described herein.

### DETAILED DESCRIPTION

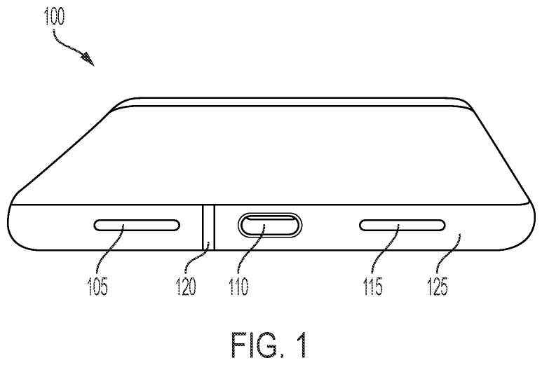

FIG. 1 is a diagram of an example mobile device 100, according to some embodiments described herein. In this example, the mobile device 100 includes a microphone 105, a universal serial bus type-C receptacle 110, a bottom speaker 115, a plastic piece 120, and a housing 125. The plastic piece 120 is positioned between the microphone 105 and the universal serial bus type-C receptacle 110. The plastic piece 120 may be an outer layer of the housing of the mobile device 100 or a plastic insert. In some embodiments, the plastic piece 120 is over molded to a metal layer of the housing 125 of the mobile device 100.

Furthermore, although the universal serial bus type-C receptacle 110 is illustrated as being part of a mobile device 110, other types of devices may include a universal serial bus receptacle, such as smart home products, wall outlets with charging ports, laptops, etc.

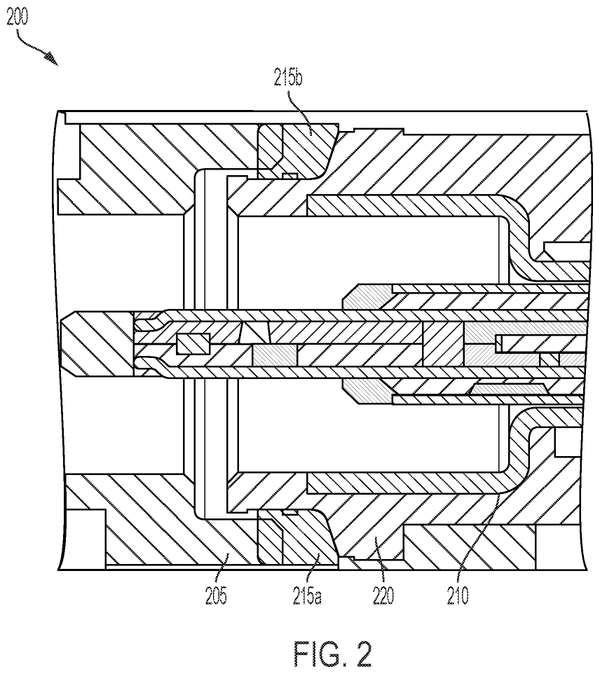

FIG. 2 is a diagram of an example universal serial bus receptacle 200 with a non-conductive O-ring, according to some embodiments described herein. The universal serial bus receptacle 200 illustrates the inside of an example of a universal serial connector with the housing removed. For example, the outer interface 105 and the metal enclosure 110 illustrated in FIG. 1 are examples of housing that is not shown in FIG. 2.

The universal serial bus receptacle 200 includes a metal enclosure 205, an inner shell 210, a non-conductive O-ring 215a, b, and a connector body 220. In some embodiments, the non-conductive O-ring 215a, b may be composed of rubber. Because the O-ring 215 is non-conductive, inner shell 210 is composed of metal and functions as an enclosure ground shell. The inner shell 210 is disadvantageous because it increases the size of the universal serial bus receptacle 200 on the z-axis.

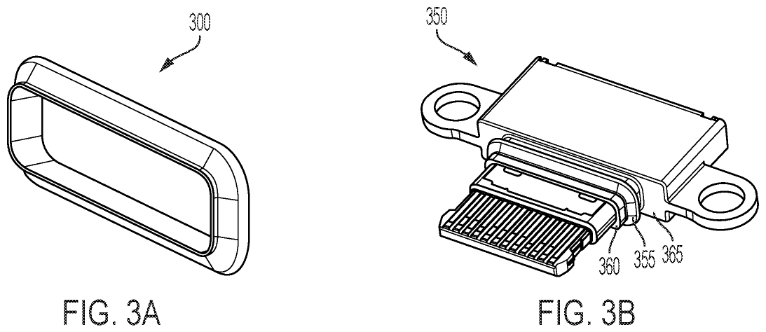

FIG. 3A is a diagram of an example conductive O-ring 300, according to some embodiments described herein. In some embodiments, the conductive O-ring 300 forms a rectangle with rounded edges. In some embodiments, the conductive O-ring 300 is made of conductive silicone. More specifically, the conductive O-ring 300 may be formed from liquid silicone rubber (LSR) during a liquid injection molding (LIM) process.

FIG. 3B is a diagram of the exterior of a universal serial bus receptacle 350 with the conductive O-ring 355, according to some embodiments described herein. The conductive O-ring 320 surrounds a metal connector body 360 that is coupled to a plastic housing 365.

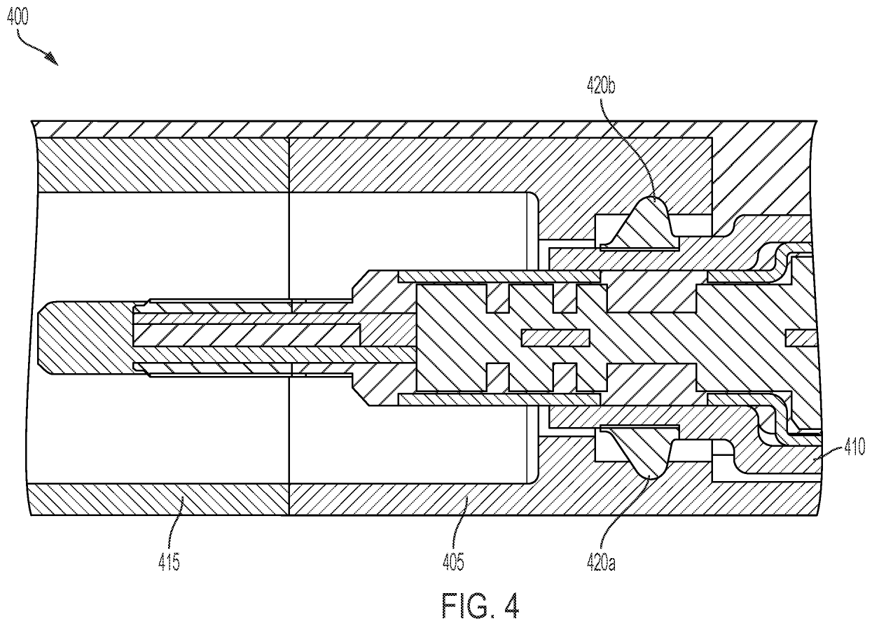

FIG. 4 is a diagram of an interior of an example universal serial bus receptacle 400 with a conductive O-ring 420, according to some embodiments described herein. The universal serial bus receptacle 400 includes a plastic part 415 of an enclosure, a metal part 405 of an enclosure, a metal connector body 410, and a conductive O-ring 420a, 420b.

The metal part 405 of the enclosure in FIG. 4 may be the metal side wall of a housing 125 of a mobile device 100, such as the mobile device 100 illustrated in FIG. 1. Alternatively, the metal part 405 of enclosure may be a conductive member as illustrated in FIG. 4 pressed into the metal wall of housing 125.

The plastic part 415 of the enclosure may be an outer layer of the housing 125. Alternatively, the plastic part 415 of the enclosure may be a plastic ring press fit into the housing 125 as illustrated in FIG. 4. The connector is positioned to be externally accessible and may, for example, be positioned as illustrated in FIG. 1.

The conductive O-ring 420 surrounds the metal connector body 410 and connects the metal connector body 410, which is the metal housing of the universal serial bus-C to the metal part of the enclosure 405, which serves as the metal wall of the housing. In some embodiments, the conductive O-ring 420 and the metal part of the enclosure 405 may be composed of aluminum. In some embodiments, the metal connector body 410 includes copper.

The conductive O-ring 420 advantageously eliminates the need for an enclosure ground shell (i.e., the inner shell 210 in FIG. 2) by using the conductive O-ring 420 as part of a shield, which contributes to the z-axis reduction of the universal serial bus receptacle 400.

The conductive O-ring 420 also provides a shielding effect that protects interference to the data signals running at high speed. For example, the conductive O-ring together with the connected housing shields the receptacle from radio frequency interference such as those carried with data signals through an electronic connector plugged into the receptacle.

Reference in the specification to “some embodiments” or “some instances” means that a particular feature, structure, or characteristic described in connection with the embodiments or instances can be included in at least one implementation of the description. The appearances of the phrase “in some embodiments” in various places in the specification are not necessarily all referring to the same embodiments.

What is claimed is:

1. A universal serial bus (USB) receptacle comprising:
an enclosure;
a metal connector body positioned adjacent to the enclosure; and
a conductive O-ring that surrounds the metal connector body and connects the metal connector body to the enclosure.

2. The receptacle of claim 1, wherein the USB receptacle is a USB-C receptacle.

3. The receptacle of claim 1, wherein the conductive O-ring forms a rectangle with rounded edges.

4. The receptable of claim 1, wherein the enclosure further comprises a plastic part and a metal part.

5. The receptable of claim 4, wherein the conductive O-ring connects the metal connector body to the metal part of the enclosure.

6. The receptable of claim 4, wherein the metal part of the enclosure is made from aluminum.

7. The receptacle of claim 1, wherein the conductive O-ring is composed of conductive silicone.

8. The receptacle of claim 1, wherein the conductive O-ring is composed of liquid silicone rubber.

9. The receptacle of claim 1, wherein the conductive O-ring is waterproof.

10. The receptacle of claim 1, wherein the conductive O-ring is made from liquid injection molding.

11. A mobile device comprising:
a housing; and
a universal serial bus (USB) receptacle comprising:
an enclosure;
a metal connector body positioned adjacent to the enclosure; and
a conductive O-ring that surrounds the metal connector body and connects the metal connector body to the enclosure.

12. The mobile device of claim 11, wherein the USB receptacle is a USB-C receptacle.

13. The mobile device of claim 12, wherein the enclosure further comprises a plastic part and a metal part.

14. The mobile device of claim 13, wherein the conductive O-ring connects the metal connector body to the metal part of the enclosure.

15. The mobile device of claim 13, wherein the metal part of the enclosure is made from aluminum.

16. The mobile device of claim 11, wherein the conductive O-ring is composed of conductive silicone.

17. The mobile device of claim 11, wherein the conductive O-ring is composed of liquid silicone rubber.

18. The mobile device of claim 11, wherein the conductive O-ring is waterproof.

19. The mobile device of claim 11, wherein the conductive O-ring shields the receptacle from radio frequency interference due to data signals carried through an electronic connector.

20. The mobile device of claim 11, wherein the conductive O-ring is made from liquid injection molding.
